(19) United States
(12) Patent Application Publication
(10) Pub. No.: US 2011/0048826 A1
(43) Pub. Date: Mar. 3, 2011

(54) POWER LINE INTERLOCK FOR ELECTRIC CAR

(76) Inventor: Gary Starr, Santa Rosa, CA (US)

(21) Appl. No.: 12/550,328

(22) Filed: Aug. 28, 2009

(51) Int. Cl. B60K 1/00; H01H 83/00; H02J 7/16

(52) U.S. Cl. 180/65.51; 307/116; 320/150

(57) ABSTRACT

Systems and method are disclosed for operating an electric vehicle. The electric vehicle has a power plug adapted to be plugged into a power line; a plurality of hub wheel motors, each hub wheel motor rotating a wheel; a controller coupled to the plurality of hub wheel motors; a charger coupled to the power plug; and a battery coupled to the charger. The vehicle includes a power interlock coupled to the power plug, the controller and the charger, where the power interlock disables the controller if the power plug is plugged into line power and other wise enables the controller to operate at least the motors.

The present invention relates to a power interlock for electric vehicles.

### BACKGROUND

In a parallel trend, the rising cost of oil and global warming indications have sensitized manufacturers and consumers to the need to be energy efficient and environmentally responsible. As a result, modern electric cars are becoming popular again. Electric cars use electric motors which drain batteries and thus the batteries need to be periodically recharged.

In regular cars, and even in normal hybrids—to a lesser, but similar, degree—the internal combustion engine drives the alternator/generator to keep the battery charged. This works well for two reasons: the engine is already running to keep the car moving, so it's also available to power the alternator, plus these relatively small starter batteries don't require much power to keep them charged, so the alternator load is light. However, in pure electric cars, the battery is the only power supply to the electric traction motor—there is no engine to drive an alternator, and using the electric traction motor to drive an alternator, or act as a generator, would be counterproductive. Since an electric car's batteries are its only source of power, they are large and require copious amounts of electricity to recharge and must be plugged in.

In general, it is cheaper, more efficient, and less polluting to plug-in an electric car for a few hours for a battery recharge, than to try and overcome the (nearly, if not completely, impossible) burden of forcing the car to produce its own electrical power. However, there are safety issues with using the AC power line to recharge the vehicle. For example, risks of fire or electric shock can exist if the vehicle is started and moved while it is plugged into the AC power line.

### SUMMARY

In one aspect, systems and methods are disclosed for operating an electric vehicle. The electric vehicle has a power plug adapted to be plugged into a power line; a plurality of hub wheel motors, each hub wheel motor rotating a wheel; a controller coupled to the plurality of hub wheel motors; a charger coupled to the power plug; and a battery coupled to the charger. The vehicle includes a power interlock coupled to the power plug, the controller and the charger, where the power interlock disables the controller if the power plug is plugged into line power and other wise enables the controller to operate at least the motors.

In another aspect, a method to recharge an electric vehicle includes providing a power interlock coupled to the power plug, the controller and the charger; and disabling the controller if the power plug is plugged into line power and other wise enabling the controller to operate at least the motors.

Advantages of the system may include one or more of the following. By disabling the vehicle controller with the interlock, safety is ensured in that a driver cannot turn on or power the drive system while the vehicle main battery pack is charging. This avoids risks of electric shocks or fire to the vehicle/occupants. The vehicle controller is re-enabled only when the power cord is unplugged from the AC power line so that the vehicle can be safely driven.

### BRIEF DESCRIPTION OF THE DRAWINGS

FIG. 1 shows an exemplary power interlock system.

FIG. 2 shows one implementation of the power interlock system.

FIG. 3 shows an exemplary power interlock process.

FIG. 4 shows an exemplary power interlock used in an electric vehicle with hub wheel motors.

FIG. 5 shows an exemplary environmentally friendly vehicle control system.

### DESCRIPTION

The following description of various disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

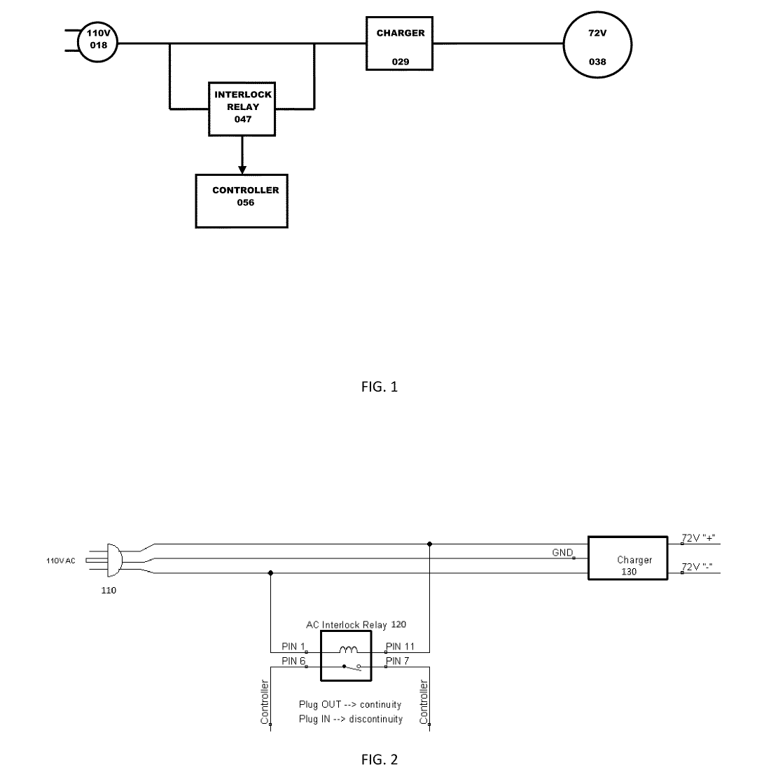

FIG. 1 shows an exemplary power interlock for electric vehicles. In the embodiment of FIG. 1, the electric vehicle is powered by a plurality of hub wheel motors which are motors directly positioned in the wheels and thus can directly drive the electric vehicle with little or no transmission gears. The motors are powered by battery packs that need recharging. The charger is powered by the AC power line when a power cord from the vehicle is plugged into the AC socket.

Referring now to FIG. 1, the AC Interlock Block 047 feature of the vehicle includes a plug 018 to connect the charging electronics into an AC 110V power supply. The connected plug 018 supplies power to a charger 029. The charger 029 converts AC power to a DC power supply and the DC power is directed to a vehicle main battery pack 038. As the vehicle main battery pack 038 is charging the AC Interlock relay 047 disables a vehicle controller 056. By disabling the vehicle controller 056 with the Interlock Relay 047 the vehicle is ensured that a driver cannot turn on or power the drive system while the vehicle main battery pack 038 is charging. When the driver or operator disconnects the plug 018 from the AC 110V power source, the Interlock relay 047 enables the vehicle controller 056 to operate. By enabling the vehicle controller 056 only when the power cord is unplugged from the AC power line, the vehicle can be safely driven.

FIG. 2 shows one implementation of the power interlock system. In this implementation, a power plug 110 can be plugged into a wall socket to get AC power. The AC power is delivered to a charger 130, and the power lines of the AC wires are provided to an AC interlock relay 120. The relay also receives a control signal from a controller (not shown) at one pin (pin 6) and, depending on the relay control signal, can either connect the control signal to another pin (pin 7) of the relay or can simply disconnect the control signal. During operation, if AC power is sensed, the relay disconnects pin 6 from pin 7 to disable the controller. Alternatively, if AC power is not sensed (not plugged in), the relay 120 connects pin 6 to pin 7 to enable the controller to operate normally. The AC Interlock prevents power from being provided to the vehicle while the vehicle is plugged in for charging. The AC interlock will be placed under the passenger seat and connected to the AC source.

The relay 120 can be a 220V model such as AIKS's relay model ART3F 110V. The unit is an electromagnetism relay with coil voltages at 380V AC/220VDC, contact capacity of 10A 24VDC/240VAC. The contact form is 3Z with a socket mounting type.

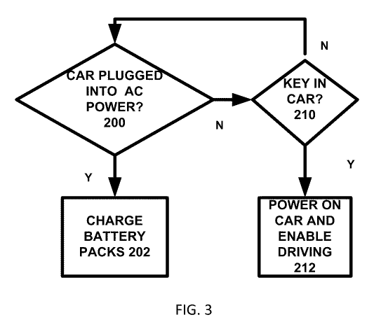

FIG. 3 shows an exemplary power interlock process. In this process, the system detects whether the vehicle has been plugged into wall power for recharging purposes (200). If so, the battery packs (primary or secondary packs) are charged (202). If not, the process proceeds to 210 where it checks if an ignition key is in the car (210). If so, the vehicle is powered on and the controller is enabled to allow the driver to operate the vehicle (212). If not, the process loops back to 200 to continue the battery charging operation.

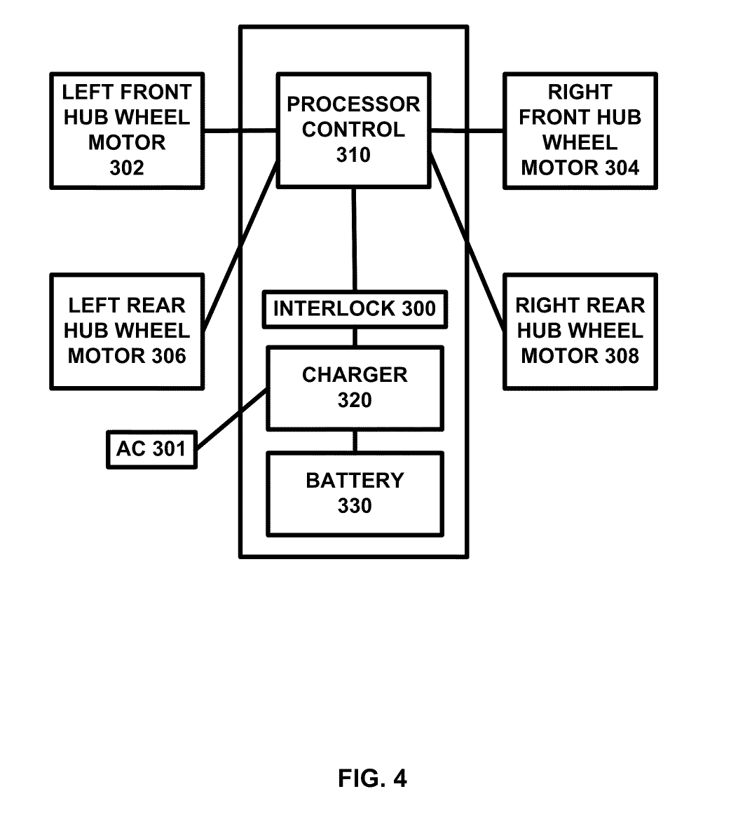

FIG. 4 shows a power interlock used in an electric vehicle with hub wheel motors 302-308. Even though 4 wheel motors are used for all wheel drive, 2 wheel motors can be mounted on the front or the back. The motors 302-308 and the power interlock 300 are controlled by a vehicle processor 310 to provide transportation to passengers located in a cab (not shown). The interlock 300 determines if the vehicle is plugged into the AC line through a plug 301. The plug 301 provides power to a charger 320 which charges battery pack(s) 330. If the vehicle is plugged into line power, the controller 310 is disabled by disconnecting a controller signal. If not, the controller 310 is connected for normal operation. In this manner, charging of the battery can be safely done.

The hub motor of FIG. 4 is designed to be small in size. The compact motor assembly is mounted in conjunction with the hub of the car. The motor assembly includes a self contained unit which includes a rotationally driven motor housing that is connected directly to the tire supporting rim of the car wheel. Rotation of the motor housing will result in similar rotation of the tire supporting rim of the wheel. The motor housing has an internal chamber and within that internal chamber is located a stator and a rotor. The stator is fixedly mounted onto a center shaft which passes through the motor housing which is fixedly mounted to the car. The rotor is to be rotated by the electrical energy being supplied to the stator with this rotation being transferred through the drive shaft.

The exemplary hub wheel motor system includes a motor enclosed by a hub cap and a tire supporting rim. A rubber wheel can be mounted on the rim. The back of the hub cap has an opening through which a cable is inserted there through to provide power as well as control signals to the motor. The motor has outer, ring-shaped permanent magnets (stator) that rotate while the inner metallic core (rotor) is fixed. When the motor is switched on, the static rotor stays still while the stator spins around it. A tire is attached to the motor, and as the outer part of the motor rotates, the wheel (or wheels) powers the vehicle forward.

The electric car with hub-wheel motors can be the Alias, available from ZAP, Inc. of Santa Rosa, Calif. The Alias is 100% electric, 100% of the time. Recharging is simple and effortless via any 110V outlet at home or on the road. The Alias has aerodynamic contours, low profile, wide stance with double-wishbone suspension, and sport styling. The vehicle can also be a truck with hub-wheel motors called ZAP Truck XL. Roomy, durable, rugged yet whisper quiet, the ZAPTRUCK XL is the affordable green solution for fleet operations. The electric truck is a utilitarian workhorse providing a roomy cab for two and a convertible bed/platform for moving up to 1600 lbs. of cargo during off-road use. The vehicle is ideal for corporate campuses, warehouses, universities, factories, municipal operations and around the ranch or farm.

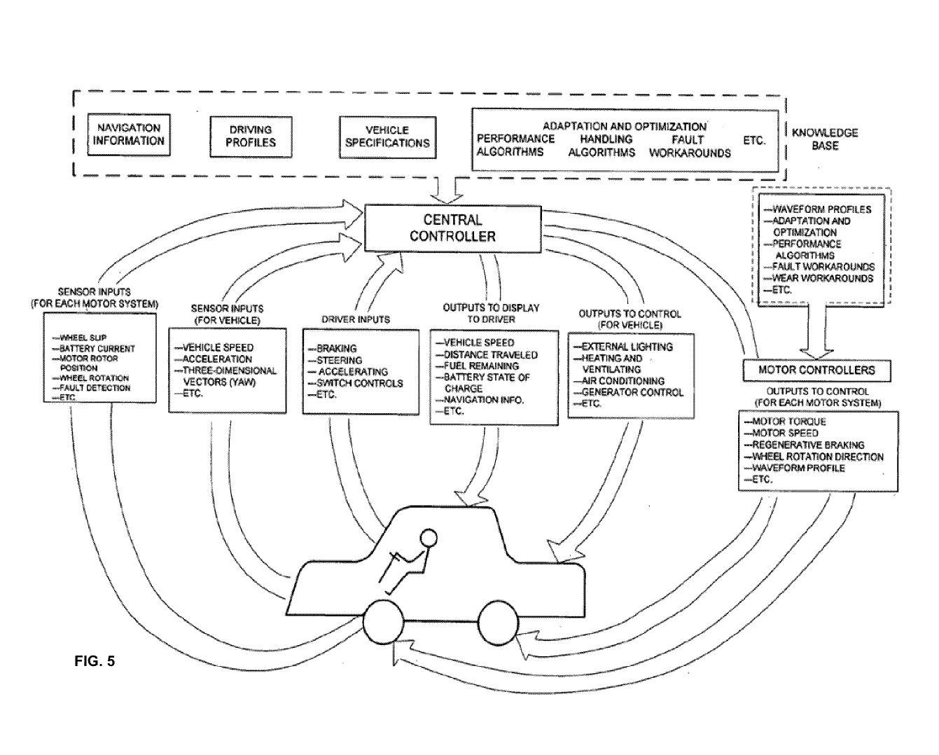

FIG. 5 shows an exemplary environmentally friendly vehicle control system that works with the power interlock of FIGS. 1-4. FIG. 5 shows how a central controller receives various inputs, draws on necessary information (driving profiles, vehicle specifications and navigation information), and produces the appropriate outputs. The central controller makes use of a range of inputs from sensors. The central controller combines this information with driver inputs received through a “user interface.” Typically, these driver inputs include braking, steering, accelerator and the various switch controls. The central controller can then combine these inputs with stored driving profiles, vehicle specifications, and navigation information. Based on all this information, the central controller optimizes for best performance. This requires sending control signals to the motors to continuously control motor torque and speed.

In one embodiment, the central controller senses temperature conditions and issues a command to maintain constant temperature given the weather condition and the occupant's desired temperature range. The central controller linearly ramps down the fan when the temperature is too high and vice versa. The user, through the user interface, can override the processor when conditions change or for any reason. In this manner, the vehicle can increase its efficiency and user comfort while minimizing environmental pollution.

The software controlling the air conditioner 300 can be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

Portions of the system and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

The system has been described in terms of specific examples which are illustrative only and are not to be construed as limiting. In addition to control or embedded system software, the system may be implemented in digital electronic circuitry or in computer hardware, firmware, software, or in combinations of them. Apparatus of the invention may be implemented in a computer program product tangibly embodied in a machine-readable storage device for execution by a computer processor; and method steps of the invention may be performed by a computer processor executing a program to perform functions of the invention by operating on input data and generating output. Suitable processors include, by way of example, both general and special purpose microprocessors. Storage devices suitable for tangibly embodying computer program instructions include all forms of non-volatile memory including, but not limited to: semiconductor memory devices such as EPROM, EEPROM, and flash devices; magnetic disks (fixed, floppy, and removable); other magnetic media such as tape; optical media such as CD-ROM disks; and magneto-optic devices. Any of the foregoing may be supplemented by, or incorporated in, specially-designed application-specific integrated circuits (ASICs) or suitably programmed field programmable gate arrays (FPGAs).

The present invention has been described in terms of specific embodiments, which are illustrative of the invention and not to be construed as limiting. Other embodiments are within the scope of the following claims. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention.

What is claimed is:

1. An electric vehicle, comprising:
a. a power plug adapted to be plugged into a power line;
b. a plurality of hub wheel motors mounted to the frame, each hub wheel motor rotating a wheel;
c. a controller coupled to the plurality of hub wheel motors;
d. a charger coupled to the power plug;
e. a battery coupled to the charger; and
f. a power interlock coupled to the power plug, the controller and the charger, the power interlock disabling the controller if the power plug is plugged into line power and other wise enabling the controller to operate at least the motors.

2. The vehicle of claim 1, wherein the battery comprises a high voltage primary battery.

3. The vehicle of claim 2, wherein the battery voltage is 72 volts or more.

4. The vehicle of claim 1, comprising a low voltage secondary battery coupled to the charger.

5. The vehicle of claim 4, wherein the low voltage secondary battery voltage is 12 volts or less.

6. The vehicle of claim 1, wherein the charger comprises a battery temperature sensor to adjust charging rate.

7. The vehicle of claim 1, wherein the power interlock comprises a relay.

8. The vehicle of claim 7, wherein the relay disconnects a controller circuit if the power plug is plugged into the power line.

9. The vehicle of claim 7, wherein the relay enables a controller circuit if the power plug is not plugged into the power line.

10. The vehicle of claim 1, wherein the power interlock comprises a switch or a transistor.

11. A method for operating an electric vehicle, the electric vehicle including a power plug adapted to be plugged into a power line; a plurality of hub wheel motors, each hub wheel motor rotating a wheel; a controller coupled to the plurality of hub wheel motors; a charger coupled to the power plug; and a battery coupled to the charger, the method comprising:
a. providing a power interlock coupled to the power plug, the controller and the charger;
b. disabling the controller if the power plug is plugged into line power and other wise enabling the controller to operate at least the motors.

12. The method of claim 11, wherein the battery comprises a high voltage primary battery.

13. The method of claim 12, wherein the battery voltage is 72 volts or more.

14. The method of claim 11, comprising a low voltage secondary battery coupled to the charger.

15. The method of claim 14, wherein the low voltage secondary battery voltage is 12 volts or less.

16. The method of claim 11, wherein the charger comprises a battery temperature sensor to adjust charging rate.

17. The method of claim 11, wherein the power interlock comprises a relay.

18. The method of claim 17, wherein the relay disconnects a controller circuit if the power plug is plugged into the power line.

19. The method of claim 17, wherein the relay enables a controller circuit if the power plug is not plugged into the power line.

20. The method of claim 11, wherein the power interlock comprises a switch or a transistor.
